(19) United States
(12) Patent Application Publication
(10) Pub. No.: US 2026/0162210 A1
(43) Pub. Date: Jun. 11, 2026

(54) IMAGING DEVICE, IMAGING SYSTEM AND METHOD FOR TRANSMITTING MEASUREMENT DATA

(71) Applicant: Siemens Healthineers AG, Forchheim (DE)

(72) Inventors: Edgar GOEDERER, Forchheim (DE); Joerg HEINRICH, Fuerth (DE); Benjamin SCHWEIKERT, Gutenstetten (DE); Peter Michael DUEPPENBECKER, Herzogenaurach (DE); Karl SCHWARZ, Roth (DE); Michael HOSEMANN, Erlangen (DE); Markus BIELE, Hetzles (DE)

(73) Assignee: Siemens Healthineers AG, Forchheim (DE)

(21) Appl. No.: 19/179,380

(22) Filed: Apr. 15, 2025

(30) Foreign Application Priority Data
Apr. 17, 2024 (EP) 24170816.3

(51) Int. Cl. G06T 1/60

(52) U.S. Cl. CPC G06T 1/60

(57) ABSTRACT

One or more example embodiments relates to an imaging system comprising an imaging device including, a capturing apparatus configured to capture and forward measurement data, the capturing apparatus including at least one capturing module configured to capture partial data, each partial data being part of entire measurement data, the imaging device is configured to create groups of partial data with the at least one capturing module, each of the groups comprises partial data from at least one of the at least one capturing module, and at least one output interface; and at least one addressing algorithm configured, based on information about a structure of data processing hardware with a plurality of target memory areas, to associate each of the groups with a target address relating to one of the target memory areas in the data processing hardware.

### CROSS-REFERENCE TO RELATED APPLICATION(S)

The present application claims priority under 35 U.S.C. § 119 to European Patent Application No. 24170816.3, filed Apr. 17, 2024, the entire contents of which are incorporated herein by reference.

### FIELD

Independent of the grammatical term usage, individuals with male, female or other gender identities are included within the term.

One or more example embodiments relates to an imaging system and a method for transmitting measurement data.

### RELATED ART

During the operation of imaging devices, in particular medical imaging devices, large volumes of measurement data are often captured that typically require further processing, in particular in the context of image reconstruction. Herein, one technical problem is the data transmission of the measurement data. For example, in a computed tomography system, measurement data has to be transmitted from a data source in an X-ray detector to an image reconstruction system so that it can be processed and reconstructed there. Another problem is efficiently coordinating the further processing of the often large volumes of measurement data.

There are already several approaches to solving this problem in the context of imaging systems. For example, the data can be sent to a receiver via an Ethernet link and then first stored in a memory of an image reconstruction system before being further processed on the image reconstruction system. For example, in the case of a computed tomography system with a rotating gantry, the data can be routed via the Ethernet link to a stationary part of the imaging system where the image reconstruction system can be located or to which the image reconstruction system can be attached. This data transmission typically comprises a plurality of further intermediate steps, which can, for example, in each case comprise encoding, sorting and/or assigning the data items to their respective station or at the respective components of the imaging system.

### SUMMARY

One or more example embodiments provides a more efficient way of transmitting data from a data source to hardware for further data processing and, if necessary, also for further processing, in particular reconstruction, of the data.

This object is achieved by an imaging system as claimed in claim 1 and a method as claimed in claim 15. Further features and advantages emerge from the dependent claims, the description and the attached figures.

### BRIEF DESCRIPTION OF THE DRAWINGS

Embodiments are described below with reference to the attached figures.

FIG. 1 is a schematic view of an imaging system according to one embodiment of the invention,

FIG. 2 is a flowchart of a method for transmitting measurement data from a capturing apparatus of an imaging device with a plurality of capturing modules to data processing hardware with a plurality of target memory areas according to one embodiment of the invention, and

FIG. 3 is a flowchart of a method for processing recorded measurement data according to one embodiment of the invention.

### DETAILED DESCRIPTION

According to one or more example embodiments of the invention, an imaging system is provided comprising an imaging device, in particular a computed tomography device, positron emission tomography device, fluoroscopy device and/or ultrasound device, wherein the imaging device comprises a capturing apparatus for capturing and forwarding measurement data. The capturing apparatus comprises at least one capturing module, in particular a plurality of capturing modules, for capturing partial data, each item of which is part of the entire measurement data, wherein the imaging device is configured to create groups of partial data with the aid of the at least one capturing module, wherein each of the groups comprises partial data from at least one of the at least one capturing module. The imaging system comprises at least one addressing algorithm configured, based on information about the structure of data processing hardware with a plurality of target memory areas, optionally distributed across a plurality of target memories, to associate the groups in each case with a target address in each case relating to one of the target memory areas in the data processing hardware. The imaging device comprises at least one output interface for forwarding the groups of partial data associated in each case with at least one target address in the direction of at least the target memory area corresponding to the target address. Advantageously, a significant simplification of data transmission can be achieved with the imaging system according to one or more example embodiments of the invention, in particular with the aid of the addressing algorithm. For example, it can be provided that individual components between the output interface and the respective target memory area of the data processing hardware only have to route the (partial) data through, wherein the target address defines the place to which the data is to be routed. In particular, it is also possible for standard components and/or standard protocols to be provided for routing through the data. The use of standard components or standard protocols enables an imaging system to be set up more cost-effectively and also simplifies the replacement of components. The fact that a target address is allocated to the respective partial data at an early stage enables a reduced number of transfers to take place between different memories. In contrast, in the prior art, the measurement data is typically only allocated to the respective target memory area in the data processing hardware and this often involves multiple transfers between different components of the data processing hardware, for example between graphics processors, the processor unit (CPU) and/or the RAM. In particular, in the case of increasing data volumes (for example due to photon-counting X-ray detectors in computed tomography systems, higher resolution and larger detectors), the addressing algorithm according to one or more example embodiments of the invention can simplify the data transmission chain and thus reduce the number of send, receive and copy operations. This enables more efficient processing architecture and a streamlined transmission chain to be achieved, in particular with a significant reduction in complexity, costs and energy.

The imaging device can in particular be a medical imaging device. For example, the imaging device can be a computed tomography device, positron emission tomography device, fluoroscopy device and/or ultrasound device. One or more example embodiments of the invention, in particular relating to addressing partial data of the measurement data and the transmission of the partial data, can be particularly advantageous in the context of a computed tomography device. However, one or more example embodiments according to the invention can also be advantageous for other imaging devices and imaging systems, in particular those with a high data transmission rate and divisible capturing modules, such as a positron emission tomography device, a fluoroscopy device and/or an ultrasound device. The capturing apparatus can, for example, be and/or comprise an X-ray detector. The capturing modules can, for example, be detector modules of the X-ray detector. In particular, the computed tomography device can comprise a rotatable gantry, wherein the X-ray detector is designed to rotate around a region of interest during a measurement. In an X-ray detector of a computed tomography device, the capturing modules or detector modules are typically spatially distributed. In the prior art, it is common practice to group the data from the different capturing modules and forward them together. In contrast, one or more example embodiments of the invention provides targeted addressing of partial data at an early stage.

The imaging device is configured to create groups of partial data with the aid of the at least one capturing module. Herein, each of the groups comprises partial data from at least one capturing module. The groups can be categorized according to predetermined criteria. It can be provided that substantially each of the groups, in particular exactly one of the groups in each case, comprise partial data from exactly one capturing module. It can be provided that one, individual, several or all of the groups comprise partial data from a plurality of capturing modules in each case. It can be provided that a plurality of items of partial data originates from one capturing module. Optionally, addressing can be provided within certain areas. For example, partial areas can be assigned to a plurality of data outputs in each case. The groups can be categorized according to metrological criteria. For example, the groups can be categorized based on a measurement location, in particular in an examination object and/or in a region of interest, from which the captured data originates. The groups can be categorized such that the items of partial data that are to be processed together by the data processing hardware, in particular in a first processing step, in each case belong to a common group of partial data. Advantageously, creating the groups can promote more efficient processing of the measurement data.

The imaging system comprises at least one addressing algorithm. Optionally it can be provided that the imaging device comprises the addressing algorithm. However, it can also be provided that the addressing algorithm is provided outside the imaging device, for example on the data processing hardware. The at least one addressing algorithm can be integrated in the capturing apparatus. In particular, the addressing algorithm can be integrated in a front end of the capturing apparatus and/or the imaging device. It can be provided that an addressing algorithm is in each case assigned to a capturing module or in each case to a group of capturing modules. The addressing algorithm is configured, based on information about the structure of data processing hardware with a plurality of target memory areas, to associate the groups in each case with a target address in each case relating to one of the target memory areas in the data processing hardware. The target memory areas are in particular part of at least one target memory. The data processing hardware can in particular be designed to process the measurement data. For example, the data processing hardware can be designed to perform image reconstruction. The data processing hardware can in particular comprise a graphics processor (GPU). The plurality of target memory areas can, for example, be part of the graphics memory. Alternatively or additionally, the plurality of target memory areas can, for example, be part of a working memory. A plurality of target memories can be provided, in particular in each case with one or more target memory areas. For example, a plurality of target memories of different graphics processors can be provided. The addressing algorithm can comprise information about the structure of the data processing hardware and/or have access to information about the structure of the data processing hardware. For example, the information can comprise a list of available target memories and/or target memory areas. The information can comprise a size of the respective target memory (memories) or the target memory areas. The information can comprise a processing time at the respective target memory area. The information can comprise a relative positioning of the target memory areas, in particular different target memories, with respect to one another. For example, the information can comprise the assignment of different target memories to different components of the data processing hardware, for example to different graphics processors.

The imaging device comprises at least one output interface for forwarding the groups of partial data associated in each case with at least one target address in the direction of at least the target memory area corresponding to the target address. The term output interface should be understood broadly in the context of the present invention. In general, an output interface refers to an interface that is configured to forward the partial data, in particular to at least one further component. The further component can be the data processing hardware directly. However, it can also be provided that there is at least one further component between the data processing hardware and the output interface. Optionally, it can be provided that the data processing hardware itself is part of the imaging device and/or the imaging system. Alternatively, the data processing hardware can also be provided externally by the imaging device. The output interface can, for example, be designed to forward the measurement data via a cable-based connection, in particular an Ethernet connection. In the case of a rotating capturing apparatus, a cable-based connection can, for example, comprise a sliding contact. Alternatively or additionally, the output interface can be designed to forward the measurement data via a wireless connection.

According to one embodiment, the imaging device comprises a plurality of integrated circuits, in particular application-specific integrated circuits, which are in each case assigned to at least one capturing module and configured to process partial data from the at least one assigned capturing module, wherein the plurality of integrated circuits in each case comprise one of the at least one addressing algorithm, or wherein the at least one addressing algorithm is part of at least one processing stage immediately downstream of the integrated circuits in the imaging device. The term “application-specific integrated circuit” (ASIC) should be understood broadly in the context of the present invention and generally refers to an electronic circuit which is realized as an integrated circuit. The plurality of integrated circuits can be designed to create the measurement data or in each case the partial data based on a signal input of the capturing modules. In particular, the integrated circuits of the plurality of integrated circuits can in each case be connected substantially directly to a signal input of the respective capturing module. Typically, a large number of application-specific integrated circuits (ASICs) is provided in a computed tomography system. For example, application-specific integrated circuits (ASICs) can be provided in the order of magnitude of 1000, for example 500-5000. Since in each case an addressing algorithm is already provided in the integrated circuits or at least in the processing stage immediately downstream of the integrated circuits, the respective target address can be assigned to the partial data at an early stage. Advantageously, therefore, further downstream components only have to forward the partial data according to the target address and re-addressing of the measurement data in later processing stages can be avoided. This means that a plurality of intermediate steps in which (re-)addressing of the measurement data would be necessary can be avoided. In particular, further processing can be enabled with the lowest possible number of transfers between different memories. This can be particularly advantageous if the addressing algorithm is in each case provided in the integrated circuits assigned to the capturing modules, in particular application-specific integrated circuits, because addressing with the target address can therefore take place even earlier. In particular, for example, this enables a further intermediate step to be avoided and/or the bandwidth required from the integrated circuit to the next processing stage to be reduced. A processing stage immediately downstream can, for example, be a (possibly further) dedicated application-specific integrated circuit (dedicated ASIC), a SoC (system-on-chip), a Sip (system-in-package), an FPGA (field programmable gate array), a DSP (digital signal processor), a CPU (central processing unit) or something similar. Providing the addressing algorithm in a downstream processing stage can have the advantage that it is typically simple to customize and test a code of the addressing algorithm. For example, an addressing algorithm in the FPGA can still be tested and developed in use until it works as desired.

According to one embodiment, the imaging device comprises at least one grouping algorithm configured to group the partial data of different capturing modules and/or different capturing times into the groups of partial data, in particular before the groups are associated with a target address by the addressing algorithm. The combining can, for example, be based on a 2×2 pixel combination, spectral mixing, etc. The at least one grouping algorithm can in particular in each case be provided in the plurality of integrated circuits, in particular application-specific integrated circuits, or the at least one processing stage immediately downstream of the integrated circuit. The grouping algorithm can, for example, be configured to group partial data in such a way that data is grouped according to logical and/or spatial cohesiveness and/or based on a temporal relationship between the data, in particular the partial data. Logical cohesiveness of the data can, for example, be based on which data is to be processed together in the data processing hardware, in particular in a first processing step. Spatial cohesiveness can, for example, be based on the fact that data originates from a common measurement location, in particular in an examination object and/or in a region of interest. Taking into account a temporal relationship between the data can in particular be helpful if a temporal relationship between data from different detectors is relevant, such as in positron emission tomography. The grouping algorithm can be configured to group measurement data of one or more recording frames. For example, the grouping algorithm be configured to group 4 to 128, preferably 8 to 64 recording frames. Advantageously, the grouping algorithm can promote efficient processing of the measurement data.

According to one embodiment, the imaging device comprises at least one compression algorithm configured to compress groups of partial data before they are transferred to the output interface, in particular before the groups are associated with a target address by the addressing algorithm. The at least one compression algorithm can in particular in each case be provided in the plurality of integrated circuits, in particular application-specific integrated circuits, or the at least one processing stage immediately downstream of the integrated circuit. The compression algorithm can be designed to compress the partial data grouped by the grouping algorithm. For example, the compression algorithm can be based on differential and/or run-length encoding. Optionally, it can be provided that the compression algorithm comprises trained artificial intelligence. For example, the compression algorithm can be implemented analogously to that described in DE 10 2010 063 435 A1.

According to one embodiment, the addressing algorithm is further configured also to define the respective target address based on at least one item of temporal information relating to the partial data. The at least one item of temporal information can in particular relate to a temporal relationship between different items of partial data. Taking into account temporal information can in particular be helpful if a temporal relationship between data from different detectors is relevant, such as in positron emission tomography.

According to one embodiment, the capturing apparatus is designed to be moved, in particular rotated, during the capturing of measurement data, wherein the at least one addressing algorithm is further configured also to define the respective target address based on the current position of the capturing modules from which the respective partial data originates. The addressing algorithm can comprise information about a relative position of the respective capturing module in the capturing apparatus and/or be designed to receive the relative position of the respective capturing module in the capturing apparatus. The imaging device can be embodied to determine a current position of the capturing apparatus and/or the capturing modules and relay this to the at least one addressing algorithm. For example, the addressing algorithm can be configured to ascertain the current position of the capturing module based on the current position of the capturing apparatus and based on information about the relative position of the respective capturing module in the capturing apparatus. By making the target address position-dependent, it is possible to ensure that the partial data in each case reaches a target memory area or target memory optimized for further processing. The respective target memory area or target memory can, for example, be specifically designed to process partial data from a specific measurement position. For example, it may be possible for the data processing hardware to automatically process the data based on a scan protocol without the data having to be addressed in the data processing hardware itself. The data processing hardware can thus start processing the data substantially directly on the basis of the target addresses that are already assigned to the partial data, wherein an assignment of the partial data is already specified by the addressing algorithm. For example, the capturing apparatus can be a rotatable X-ray detector, in particular of a computed tomography system. In the case of a computed tomography system with a rotatable X-ray detector, it is typically necessary to group data from different spatial regions. Due to the rotation, a similar physical position can originate from different capturing modules or even different integrated circuits attached thereto. For example, it can be expedient always to address data from a specific rotational position, for example the 9 o'clock position, to the same target memory area or set of target memory areas. Accordingly, the respective recipient of the data processing hardware can assume that the partial data it receives in each case originates from a specific position, so that no further assignment is necessary.

According to one embodiment, the addressing algorithm is further configured also to define the respective target address based on a logical and/or physical position of the target memory areas, in particular a plurality of target memories, in the data processing hardware. In particular it can be provided that the data processing hardware comprises a plurality of hardware components and the addressing algorithm addresses a specific one of the plurality of hardware components in the respective target address. A plurality of hardware components can, for example, be or comprise a plurality of graphics processors. Accordingly, a physical position can, for example, be a position of the target memory area or target memory in one of a plurality of hardware components in each case. For example, it can be provided that different types of partial data, which are to be processed together initially or in a later step, are in each case addressed to a target memory area or target memory of the same hardware component, for example the same graphics processor. A logical position can, for example, be a target address in the data processing hardware that is configured to further process a specific type of data, for example data from a specific position or data recorded according to a specific parameter. A specific parameter can, for example, be an energy threshold, a voltage used and/or a specific frequency, etc. A logical position can optionally also be a position which, according to information stored in the addressing algorithm and based on the previously sent partial data and its target addresses, is expected to be currently free for the recording of further partial data.

According to one embodiment, the at least one addressing algorithm is configured also to define the target addresses in each case based on information about a processing time of the data processing hardware at the respective target memory area, so that the resending of partial data in a target memory area is coordinated with the release of the target memory area. In particular, this embodiment can be used on the one hand to ensure that items of partial data from successive transmissions do not overwrite one another and on the other hand to enable the most efficient use of the data processing hardware by ensuring that computing power is not wasted due to target memory areas temporarily remaining empty for too long. The addressing algorithm can thus be configured to take into account the time and optionally the type of the partial data previously sent together with the processing time at the respective target address in order to specifically time the refilling of the target memory areas with new partial data. If, for example, the memory of a graphics processor of the data processing hardware enables the data from two complete rotations of a rotatable capturing apparatus to be stored, with a rotation time of 0.2 seconds, it can be provided that the same memory area is only overwritten again after 400 milliseconds. Accordingly, the further processing of the partial data in the respective block of the target memory should be reliably completed in this time window.

According to one embodiment, the imaging system, in particular the imaging device, and the addressing algorithm are configured such that the addressing algorithm can be parameterized by an input, wherein the ability to be parameterized can in particular be provided in dependence on measurement parameters provided in a measurement protocol. The addressing algorithm can, for example, have different configuration registers. For example, the addressing algorithm can be set to different operating modes, which in particular in each case correspond to a different parameterization. The ability to be parameterized can comprise setting different transmission modes of the measurement data or partial data. The measurement parameters can, for example, comprise a rotation time, a frame rate, Z-coverage, a threshold value and/or spatial resolution. The ability to be parameterized can be coordinated with at least one property of the data processing hardware. For example, the ability to be parameterized can be coordinated with a system configuration of the data processing hardware. A system configuration can, for example, be a number, type, and/or expansion stage of graphics processors of the data processing hardware. For example, the addressing algorithm can comprise different operating modes coordinated with the property, in particular system configuration, of the data processing hardware. The ability to be parameterized enables the imaging system and the addressing algorithm to be used more flexibly, in particular in different contexts, with different data processing hardware and/or in different measurement modes. For example, in the context of a computed tomography system, a transition between dual-source and single-source systems can substantially only require reparameterization of the algorithm. An increase in the threshold number of the detector modules of the computed tomography system can substantially be achieved by adapting the plurality of integrated circuits, in particular application-specific integrated circuits, parameterizing of the addressing algorithm and processing in the data processing hardware, in particular the graphics processor-internal processing. In particular if there is sufficient bandwidth and processing capacity, this can be achieved with little impact on other components. In other words, it may only be necessary to adapt the end components, while all intermediate components can remain unaffected. In contrast, in current systems according to the prior art, such a change would require the adaptation or replacement of virtually every component on the data transmission path. Advantageously, the ability to be parameterized can, for example, largely eliminate the need for a side channel for data transmission of the partial data between transmitter and receiver, because synchronization via the side channel may no longer be necessary. This can be enabled by the fact that the ability to be parameterized means the data can already be suitably coordinated, even for different types of data processing hardware or different measurement modes. Advantageously, the processing architecture can thus be made more efficient and less complex. Costs and energy consumption can also be reduced.

According to one embodiment, the imaging device and/or the at least one output interface is/are configured to forward the groups of partial data in each case in the direction of at least one additional data memory. Advantageously, the measurement data can thus also be stored as raw data, for example for subsequent further processing or checking.

According to one embodiment, the imaging system comprises data processing hardware with a plurality of target memory areas, optionally distributed across a plurality of target memories, wherein the data processing hardware in particular comprises at least one graphics processor, wherein the data processing hardware is and/or can be connected to the at least one output interface by a data-related interconnection and is configured to process the groups of partial data, in particular in the context of image reconstruction. The plurality of target memory areas can, for example, be part of the graphics memory. The data processing hardware can optionally comprise a plurality of graphics processors. The data processing hardware can in particular be designed to perform image reconstruction based on the measurement data. The at least one graphics processor can be designed to perform data reconstruction internally and only output a fully reconstructed image, for example a reconstructed cross-sectional image. The data processing hardware is designed to further process incoming partial data. In particular, the data processing hardware can be designed such that complete further processing is performed within at least one graphics processor. The data processing hardware can be designed to decompress incoming partial data and prepare it using a preprocessing stage. Decompression and the preprocessing stage can preferably already be part of the further processing within the at least one graphics processor. The preprocessing stage can, for example, comprise applying corrections to the partial data. The preprocessing stage can also be referred to as a prep chain. After the preprocessing stage, in particular at least one further processing stage is provided. In particular, the at least one further processing stage can be designed to perform image reconstruction. The at least one further processing stage can comprise at least one rebinning stage, in particular for converting the data prepared in the preprocessing stage into at least one set of projections.

According to one embodiment, the data processing hardware is configured to route the groups of partial data directly to the associated target memory area based on the associated target addresses and to process the partial data at the location of the target memory area, wherein the data processing hardware is optionally configured to relay the partial data to another storage location in the data processing hardware after processing in the target memory area and to process it there. In addition to the one further storage location, one or more further storage locations can be provided. The target memory area and the (at least one) further storage location can in each case be assigned to a processing stage of the data processing hardware, in particular at least one graphics processor of the data processing hardware. It can be provided that the partial data is transferred to a new storage location after each processing stage. In particular it can be provided that individual intermediate results are only retained in a respective storage location for as long as they are required for the calculations of the respective processing stage. Corresponding to a ring buffer, the respective data can then be overwritten by further data from the previous processing stage or from the output interface of the imaging device. For example, it can be provided that the partial data is transferred to the further storage location at the latest after rebinning has been calculated. The imaging system can be designed to overwrite the target memory area with further partial data at the latest after the rebinning has been calculated. It can also be provided that the partial data is relayed to another storage location in the data processing hardware after it has been decompressed. Alternatively, it can be provided that the partial data is relayed to another storage location in the data processing hardware during or after the prep chain. In particular the shorter the required processing time required at the target memory, the smaller the number of available target memory areas for the data transmission can be. Such a concatenation, with which in particular the storage locations can be used as a ring buffer, can enable a complete processing pipeline to be achieved within the data processing hardware, in particular within a graphics processor, with a reduced memory requirement. Thus, the processing architecture can be made even more efficient.

According to one embodiment, the at least one output interface is connected to the target memory areas or the at least one target memory of the data processing hardware via Remote Direct Memory Access (RDMA). An RDMA connection between the output interface and the target memory areas can in particular be a way of transmitting the partial data to the respective target memory area without the influence of further control software. In particular, the transmission can, for example, be provided without the direct influence of a CPU. In particular, this enables CPU-related bottlenecks to be avoided. RDMA can enable a particularly direct concatenation of the output interface, for example application-specific integrated circuits (ASIC), with the target memory areas, for example at least one graphics processor. The RDMA connection can, for example, be designed as ROCE (RDMA over converged Ethernet). It can be provided that resend buffer mechanisms are used. Resend buffer mechanisms commonly used in the prior art can be used for this purpose. This can make the system more robust against possible interference in the data transmission. For example, RDMA can be operated in a “reliable connected mode” in order in particular to use existing protocol-inherent backup mechanisms. A further advantage of RDMA can be that in particular everything that occurs in an OSI model under layer 4 (the transport layer according to the OSI model according to ISO) can be achieved by standardized hardware. For example, decoding no longer has to take place on a CPU, but can take place directly in a graphics processor comprising at least one of the target memories. In the context of RDMA read/write operations, the addressing algorithm can, for example, be provided on a transmitter side, in particular on the imaging device. Alternatively, the addressing algorithm can be provided on a receiver side, for example in the context of RDMA send/receive operations, for example on the processing hardware. Thus, in particular, transmitter-side addressing or receiver-side addressing can be provided. In the case of receiver-side addressing, it can be provided that the receiver stores corresponding memory areas for incoming messages in so-called receive queues. In particular, the addressing algorithm can be configured to execute this function. Incoming messages can then in particular be written to the stored target memory areas without the intervention of a CPU. It is therefore possible that the transmitter itself, in particular on the imaging device side, does not know the specific memory-target address, only the receiver knows this. Accordingly, with this option, the addressing algorithm can be located primarily on the receiver side. This variant can facilitate synchronization mechanisms, for example the avoidance of overwriting memory areas that have not yet been processed. The option according to which the addressing algorithm is provided on the transmitter side can advantageously enable addressing at an even earlier stage, which can save processing time and capacity on the receiver side.

According to one embodiment, transmission from the at least one output interface to the target memory areas is provided via gather/scatter addressing. Gather/scatter addressing enables the partial data to be collected (gather) and, after transmission to the desired target memory area in the data processing hardware, in particular on at least one graphics processor, distributed (scatter). In particular, the scatter-option can enable distribution to none-contiguous target memory areas. The use of gather/scatter addressing enables efficient and conceptionally lean association of the capturing modules with the data processing hardware, in particular the processing stages of the data processing hardware. In addition, any re-sorting that would otherwise be necessary can be saved. In particular, the measured partial data can, for example, reach the target memory areas in the data processing hardware in a single step, so that further processing can take place with the lowest possible number of transfers between memories or memory areas. A scatter operation can in particular be implemented with receiver-side addressing.

According to one embodiment, the imaging system is designed to send the partial data from the at least one output interface to the target memory areas via a plurality of data channels, in particular via one data channel per integrated circuit (in particular ASIC), which is in each case assigned to a capturing module. This embodiment can in particular be associated or implemented with an RDMA connection. Splitting into a plurality of data channels enables more flexible data routing and better load balancing of the individual data streams. Moreover, small data channels can save on hardware. For example, it is possible to use a slower CPU since it only has to forward the data of the individual data streams already addressed by the addressing algorithm. The plurality of data channels enables high segmentation of data transmission by sending numerous small data packages instead of individual large data packages. The main advantage of high segmentation for data transmission is that resending or data interpolation takes place on a substantially lower data volume. As a result, complexity, space requirements, memory requirements, bandwidth requirements, energy requirements, latency and thus also costs can be reduced while maintaining the same functionality.

According to one embodiment, the imaging system comprises a data memory for storing measurement data, wherein the imaging system and/or the at least one output interface is configured to send the measurement data in each case in addition to the at least one data memory, wherein the data memory is configured to store the measurement data. For example, the imaging system can be designed to multicast the data to the additional data memory. The additional data memory can, for example, be an NVMe memory (NVM Express memory), in particular a directly addressable NVMe memory. In particular, the measurement data can thus, for example, also be stored for subsequent further processing or checking, including as raw data, in particular in parallel with the processing of the measurement data with the data processing hardware. The data memory can be part of the imaging system. The data memory can optionally be a remote memory. For example, the data memory can also be connected to the imaging system via a network and/or the internet.

Alternatively or additionally, the imaging system can be designed to extract data partially processed by the data processing hardware and send it to the data memory. Data partially processed by the data processing hardware can, for example, be decompressed data, prepped or preprocessed data, data after rebinning and/or data after convolution. Alternatively or additionally, the imaging system can be designed to send fully processed data, such as reconstructed image data, from the data processing hardware to the data memory. Reconstructed image data can, for example, be cross-sectional images or a set of cross-sectional images and/or three-dimensional image data.

One or more example embodiments of the invention is an imaging device, in particular as described herein. The imaging device can in particular be a computed tomography device, a positron emission tomography device, a fluoroscopy device and/or an ultrasound device. The imaging device comprises a capturing apparatus for capturing and forwarding measurement data, wherein the capturing apparatus comprises at least one capturing module, in particular a plurality of capturing modules, for capturing partial data, which is in each case part of the entire measurement data, wherein the imaging device is configured to create groups of partial data with the aid of the at least one capturing module, wherein each of the groups comprises partial data from at least one of the at least one capturing module. Optionally, the imaging device comprises at least one addressing algorithm configured, based on information about the structure of data processing hardware with a plurality of target memory areas, optionally distributed across a plurality of target memories, to associate the groups in each case with a target address in each case relating to one of the target memory areas in the data processing hardware. Alternatively, the addressing algorithm can be provided outside the imaging device, for example on the data processing hardware. The imaging device comprises at least one output interface for forwarding the groups of partial data associated in each case with at least one target address in the direction of at least the target memory area corresponding to the target address. All advantages and features of the imaging system can be transferred analogously to the imaging device and vice versa.

One or more example embodiments of the invention is a method for transmitting measurement data from a capturing apparatus of an imaging device with at least one capturing module, in particular a plurality of capturing modules, to data processing hardware with a plurality of target memory areas, optionally distributed across a plurality of target memories, comprising the following steps:
creating groups of partial data of the measurement data of the at least one capturing module;
associating the groups in each case with a target address in each case relating to one of the target memory areas, preferably via an addressing algorithm, in particular based on information about the structure of the data processing hardware with the plurality of target memory areas;
forwarding the groups of partial data to the target memory areas, wherein the partial data in the data processing hardware is assigned directly to the respective target memory areas based on the target addresses.

All the advantages and features of the imaging device and the imaging system can be transferred analogously to the method for transmitting measurement data and vice versa.

One or more example embodiments of the invention is a method for processing recorded measurement data. The method for further processing measurement data can comprise the steps of the method for transmitting measurement data and additionally the following step:
processing, in particular reconstructing, the measurement data in the data processing hardware.

All the advantages and features of the imaging device, the imaging system and the method for transmitting measurement data can be transferred analogously to the method for processing recorded measurement data and vice versa. Processing can in particular be provided on at least one graphics processor of the data processing hardware. Processing can comprise decompressing the partial data. Processing can comprise preprocessing the partial data in a preprocessing stage. Preprocessing can comprise applying corrections to the partial data. After preprocessing, in particular at least one further processing step is provided, in particular comprising image reconstruction. Processing can comprise rebinning the partial data, in particular for converting the data prepared in the preprocessing stage into at least one set of projections. Processing can include convolving the projections with a filter core. Processing can comprise step-by-step use of the convolved data by a back projector for calculating image data, in particular cross-sectional images. A final processing step can comprise storing the processed data, for example as DICOM data. Preferably, individual intermediate results of the processing are only retained for as long as they are required for the calculations of the respective processing step. In particular, the data in each stage is preferably overwritten by new data from the previous stage or by the partial data from the capturing modules after the completion of each processing step.

All embodiments described herein can be combined with one another unless explicitly stated otherwise.

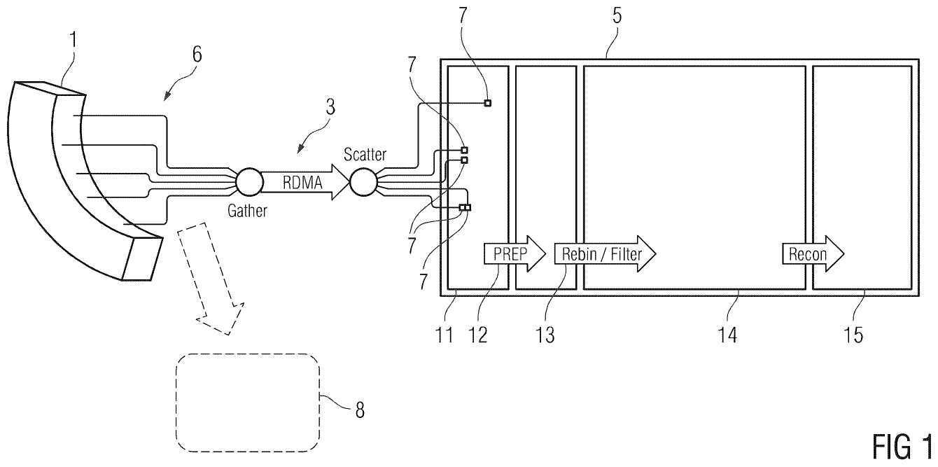

FIG. 1 is a schematic view of an imaging system according to one embodiment of the invention. In this exemplary embodiment, the imaging system is a computed tomography system with a rotatable gantry (not shown). The gantry comprises a capturing apparatus 1 consisting of capturing modules in a partially circular arrangement for detecting X-rays. However, example embodiments can also be used analogously for other types of imaging systems. The capturing modules of the capturing apparatus 1 in each case comprise application-specific integrated circuits (ASICs) in which incoming signals are electronically recorded and forwarded.

The measurement data, for example spectral measurement data, from one or more frames are suitably grouped and compressed as partial data in the respective ASIC, or alternatively in an immediately downstream stage of the capturing modules of the capturing apparatus 1. The downstream stage can, for example, be a dedicated ASIC, a SoC (system-on-chip), a SiP (system-in-package), an FPGA, a DSP, a CPU or something similar. An addressing algorithm, which is provided in the ASICs in each case, is used to associate the respective partial data with a target address 7 relating to a target memory area. Herein, the addressing algorithm ascertains a suitable target address 7, A, in the memory of a graphics processor 5 (GPU) of the image processing hardware based on a position [X, Y] of the ASIC in the capturing apparatus 1 stored in the ASIC or retrieved externally in the capturing apparatus 1 and on the position of the capturing apparatus 1, 0. If there is a plurality of graphics processors 5, the addressing algorithm also determines the GPUID of the relevant target GPU. By making the address position-dependent, it is possible to ensure that the partial data is delivered to a target area optimized for further processing and that the data items from successive transmission do not overwrite one another. The addressing algorithm f

$$f ( X , Y , θ ) = [ A , GPUID ]$$

enables it to be ensured that data in the memory of the graphics processor 5 is only overwritten after the further processing of this area in the graphics processor 5 has been completed. Suitable interlocking of the addressing and real-time further processing of the blocks in the graphics processor 5 can be coordinated with one another, in particular with regard to the specific purpose of the imaging system and, for example, the measurement modes provided. If, for example, the memory of the graphics processor 5 enables storage of the data from two complete rotations of the capturing apparatus 1 in the gantry, with a rotation time of 0.2 seconds, the same memory area is only overwritten again after 400 milliseconds. In this time window, further processing of this block in the graphics processor 5 should be guaranteed to be completed.

The partial data is sent as data packages via a plurality of data channels 6 via an output interface. For example, transmission over Ethernet can be provided. In this exemplary embodiment, the data packages are RDMA-addressed and are transmitted via an RDMA chain (for example via ROCE, RDMA over converged Ethernet) and delivered to the target locations in the memory of the graphics processor 5. Herein, gather/scatter addressing 3 is used to collect the partial data from the different ASICs (gather) and distribute it after transmission to the desired memory areas on the graphics processor 5 (or on the different graphics processors 5) (scatter). Alternatively or additionally to the graphics processor 5, the data can also be routed to a data memory 8 (for example a directly addressable NVMe memory) for example via multicast where it can in particular be stored as raw data. If the raw data is not stored on the data memory 8, it can be provided that the result of the processing in the graphics processor 5 or the graphics processors 5 is such that all the data required for further diagnosis is received. For example, the result of the processing could be a set of high-resolution (sharp) cross-sectional images. Alternatively, the extraction of partially processed data (for example decompressed data, prepped data, data after rebinning or data after convolution) could also be provided in an earlier processing step. In order to make the system more robust against possible interference in the data transmission, common resend buffer mechanisms can optionally be provided. For example, RDMA can be operated in a “reliable connected mode” for this purpose, thus allowing protocol-inherent backup mechanisms to be used.

The partial data arriving at the respective target addresses 7 is further processed in the graphics processor 5. Ideally, the final result (for example in the form of reconstructed cross-sectional images) must first be read out of the graphics processor 5. For example, the final result can be stored as DICOM data. Advantageously, the data no longer needs to be addressed in the data processing hardware, but can be further processed directly using the addressing algorithm because it has already been addressed. This can enable significantly faster and more efficient processing in the data processing hardware. In this exemplary embodiment, further processing first involves decompressing the data in a preprocessing stage 11 and applying a prep chain 12. In the prep chain, corrections, in particular predominantly local corrections, are applied to the measurement data. The prepped data is then converted via a rebinning stage 13 from raw data, in particular fan-shaped raw data, into a set of projections 14. The projections 14 are then convolved with a filter core and the convolved data is used step-by-step by a back projector to calculate the reconstructed image data 15, in particular cross-sectional images. For example, different sets of slice images can be combined and transformed (for example into VNC, mono-keV, iodine images, etc.) and desired views or sections can be calculated. The structure according to one or more example embodiments of the invention creates a GPU-internal pipeline with which the individual intermediate results only have to be retained for as long as they are required for the calculations of the subsequent processing stage. They are then overwritten by new data from the previous stage or from the detector (ring buffer). The memory block originally used for the data transfer can therefore be overwritten again at the latest after rebinning has been calculated. Alternatively, the result can be stored in a different memory area after the decompression or during the prep chain so that the original memory block can be overwritten earlier. The shorter the required processing time, the smaller the number of available target areas for the data transmission can be. Optionally, different transmission modes and parametrizations can be supported. For example, the modes could differ in rotation time, frame rate, Z-coverage, threshold value and spatial resolution. Furthermore, there can also be different system configurations with different numbers, types and expansion stages of graphics processors 5 to which the addressing algorithm is adapted. Advantageously, for this purpose, it can be provided that the addressing algorithm can be parameterized externally, for example via configuration registers.

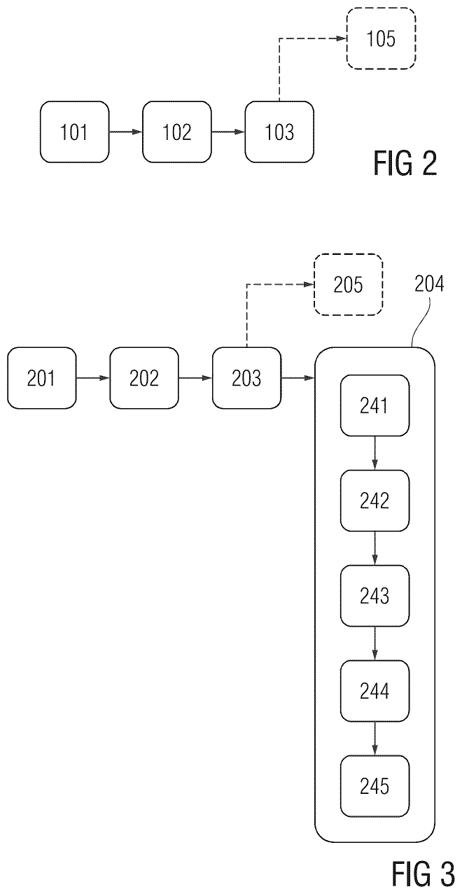

FIG. 2 is a flowchart of a method for transmitting measurement data from a capturing apparatus 1 of an imaging device with a plurality of capturing modules to data processing hardware with a plurality of target memory areas according to one embodiment of the invention. In a first step 101, groups of partial data of the measurement data of the capturing modules are created. Herein, in particular each of the groups comprises partial data from at least one capturing module. The groups can in particular be created with a grouping algorithm, which is configured to group the partial data from different capturing modules and/or different capturing times into the groups of partial data. Preferably, the groups of partial data can also be compressed by a compression algorithm. In a further step 102, the groups are in each case associated with a target address 7 in each case relating to one of the target memory areas, in particular based on information about the structure of data processing hardware with a plurality of target memory areas. The association is in particular performed via an addressing algorithm as described herein. The association is preferably performed in integrated circuits, in particular application-specific integrated circuits, of the capturing modules or in a processing stage immediately downstream of the integrated circuits in the imaging device. In the case of a moving capturing apparatus 1, for example a rotatable capturing apparatus 1 in a gantry of a computed tomography device, it can be provided that the respective target address 7 is also defined based on the current position of the capturing modules from which the respective partial data originates. Optionally, the addressing algorithm can further be configured also to define the respective target address 7 based on a logical and/or physical position of the target memory areas or a plurality of target memories in the data processing hardware and/or based on information about a processing time of the data processing hardware at the respective target memory area, so that the resending of partial data to a target memory area is coordinated with the release of the target memory area. In a further step 103, the groups of partial data are routed to the target memory areas, for example via Remote Direct Memory Access and with gather/scatter addressing 3, wherein the partial data in the data processing hardware is assigned directly to the respective target memory areas based on the target addresses 7. In an optional step 105, it can also be provided that the measurement data is in each case sent additionally to at least one data memory 8.

FIG. 3 is a flowchart of a method for processing recorded measurement data according to one embodiment of the invention. Steps 201-203 and the optional step 205 can correspond to steps 101-103 and 105 of the method described with reference to FIG. 2. In a further step 204, the measurement data is processed in the data processing hardware, in particular reconstructed into image data 15. The further step 204 comprises a plurality of sub-steps. In an (optional) first sub-step 241, the partial data is decompressed if it was previously compressed. In a further sub-step 242, a prep chain is applied in which predominantly local corrections are applied to the partial data. In a further sub-step 243, the prepped data is converted into a set of projections 14 by rebinning. The projections 14 are then convolved with a filter core in a further sub-step 244. In a further step 245, the convolved data is used step-by-step by a back projector to calculate the reconstructed image data 15, in particular cross-sectional images.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will: further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. An imaging system comprising:
an imaging device including,
a capturing apparatus configured to capture and forward measurement data, the capturing apparatus including at least one capturing module configured to capture partial data, each partial data being part of entire measurement data,
the imaging device is configured to create groups of partial data with the at least one capturing module, each of the groups comprises partial data from at least one of the at least one capturing module, and
at least one output interface; and
at least one addressing algorithm configured, based on information about a structure of data processing hardware with a plurality of target memory areas, to associate each of the groups with a target address relating to one of the target memory areas in the data processing hardware, the at least one output interface configured to forward each of the groups of partial data associated in with at least one target address in a direction of at least the target memory area corresponding to the target address.

2. The imaging system of claim 1, wherein the imaging device comprises,
a plurality of integrated circuits, each of the plurality of integrated circuits assigned to at least one capturing module and configured to process partial data from the at least one assigned capturing module, and
each of the plurality of integrated circuits comprises one of the at least one addressing algorithm, or the at least one addressing algorithm is part of at least one processing stage immediately downstream of the integrated circuits in the imaging device.

3. The imaging system of claim 1, wherein the imaging device comprises,
at least one grouping algorithm configured to group at least one of the partial data of different capturing modules or different capturing times into the groups of partial data.

4. The imaging system of claim 1, wherein the imaging device comprises,
at least one compression algorithm configured to compress groups of partial data before they are transferred to the output interface.

5. The imaging system of claim 1, wherein the capturing apparatus is moveable during the capturing of measurement data, wherein the at least one addressing algorithm is further configured to define the respective target address also based on a current position of the capturing modules from which the respective partial data originates.

6. The imaging system of claim 5, wherein the addressing algorithm is further configured to define the respective target address based on at least one of a logical position or a physical position of the target memory areas in the data processing hardware.

7. The imaging system of claim 1, wherein the at least one addressing algorithm is configured also to define each target address based on information about a processing time of the data processing hardware at the respective target memory area such that a resending of partial data to a target memory area is coordinated with a release of the target memory area.

8. The imaging system of claim 1, wherein the imaging device and the addressing algorithm are configured such that the addressing algorithm is parameterizable by an input.

9. The imaging system of claim 1, further comprising:
data processing hardware including a plurality of target memory areas, wherein the data processing hardware is connectable to the at least one output interface by a data-related interconnection and is configured to process the groups of partial data.

10. The imaging system of claim 9, wherein the data processing hardware is configured to route the groups of partial data directly to the associated target memory area based on the associated target addresses and to process the partial data at a location of the target memory area.

11. The imaging system of claim 9, wherein the at least one output interface is connected to the target memory areas of the data processing hardware via Remote Direct Memory Access.

12. The imaging system of claim 11, wherein transmission from the at least one output interface to the target memory areas is provided via gather/scatter addressing.

13. The imaging system of claim 9, wherein the imaging system is configured to send the partial data from the at least one output interface to the target memory areas via a plurality of data channels.

14. The imaging system of claim 9, wherein
the imaging system comprises a data memory configured to store measurement data, and
at least one of the imaging system or the at least one output interface is configured to send the measurement data to the at least one data memory, wherein the data memory is configured to store the measurement data.

15. A method for transmitting measurement data from a capturing apparatus of an imaging device with at least one capturing module to data processing hardware with a plurality of target memory areas, the method comprising:
creating groups of partial data of the measurement data of the at least one capturing module;
associating each of the groups with a target address relating to one of the target memory areas via an addressing algorithm; and
forwarding the groups of partial data to the target memory areas, wherein the partial data in the data processing hardware is assigned directly to the respective target memory areas based on the target addresses.

16. The imaging system of claim 5, wherein the capturing apparatus is rotatable during the capturing of measurement data.

17. The imaging system of claim 8, wherein
the addressing algorithm is parameterizable based on measurement parameters provided in a measurement protocol.

18. The imaging system of claim 9, wherein
the plurality of target memory areas are distributed across a plurality of target memories, and
the data processing hardware includes at least one graphics processor.

19. The imaging system of claim 10, wherein the data processing hardware is configured to relay the partial data to another storage location in the data processing hardware after processing in the target memory area and to process the partial data at the another storage location.

20. The imaging system of claim 13, wherein the imaging system is configured to send the partial data from the at least one output interface to the target memory areas via one data channel per integrated circuit, which each data channel being assigned to a capturing module of the at least one capturing module.
